(19) United States
(12) Patent Application Publication
(10) Pub. No.: US 2004/0008823 A1
(43) Pub. Date: Jan. 15, 2004

(54) Method for controlling a link in a telecommunication network

(76) Inventors: Robert Kindermann, (US); Karl Knobl, (US)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/460,232

(22) Filed: Jun. 13, 2003

Related U.S. Application Data
(63) Continuation of application No. PCT/EP01/05455, filed on May 14, 2001.

(30) Foreign Application Priority Data
Apr. 30, 2001 (AT) A 695/2001

(51) Int. Cl. H04M 1/24; H04M 3/22

(52) U.S. Cl. 379/1.01; 379/32.01; 379/90.01

(57) ABSTRACT

The invention relates to a system and method for controlling a link in a telecommunication network, whereby a model of connection is produced in a programmable computer and a measure to be implemented in the telecommunication network is derived with the aid of the behavior of the model based on a measure already implemented. The invention also relates to a network configuration for bearer independent call control networks.

### CROSS REFERENCE TO RELATED APPLICATIONS

The present application claims is a continuation of international patent application PCT7EP01/05455, filed May 14, 2001 and claims priority to Austrian patent application number A 695/2001, filed Apr. 30, 2001, both of which are herein incorporated by reference.

### BACKGROUND OF THE INVENTION

The present invention relates generally to the field of telecommunications and more particularly to a method for controlling a link in a telecommunication network and in particular a connection between at least a first and a second telecommunication terminal. The present invention also relates to an arrangement for carrying out the present method according to the invention.

The structure of telecommunication networks and the principles which such telecommunication networks follow generally result in information about the status of a link, which information is necessary inter alia for controlling such a link, being distributed over the telecommunication network.

In conventional telecommunication networks, for example, which operate in accordance with the Time Division Multiplexing method (abbreviated to TDM method), a hierarchically structured destination address is evaluated in order to establish the required connection. Starting from country and local dialing prefixes, the relevant connections are switched between the individual switching nodes of a telecommunication network, with as a rule only one part of the call number being processed at any one switching node. In particular, only the unprocessed part of the call number is forwarded to the next switching node. Thus, the switching of a connection follows a hierarchical principle.

In the case of this telecommunication network, a switching node functions essentially autonomously. From the switching node measures can therefore also be implemented by means of which adjacent switching nodes but not the endpoints are, optionally, informed. This results in information about the status of a link being distributed over the telecommunication network. A way of examining the link in its entirety is therefore not generally possible or only with difficulty.

For the reasons cited, no comprehensive information about the status of the link, in particular no information about another endpoint of the connection, is available at the endpoints of the link. Also, it is not usually possible to directly influence switching nodes which are not directly adjacent to the endpoint, by means of a command entered at the endpoint. Thus, a telecommunication network of this type also follows the principle that not every part of the connection can be influenced from the endpoint directly but only indirectly.

However, for many tasks, including for controlling a link, it is, for example, necessary to obtain information about the status of said link at any point or else to influence segments of said link from said point and thereby to control the connection. The endpoints, in particular, have a significant role to play in this context.

Connections are defined in this context as referring not only to links between two points in a telecommunication network, but also to links between multiple endpoints. The case where one link is converted into another is also a key aspect here. An example would be the switch from a link between two telecommunication terminals to a conference circuit involving three or more subscribers and vice versa. Another case is the function known as “toggle” or “call waiting”, whereby a link can be established from a first telecommunication terminal alternatively to a second or third telecommunication terminal. Here, the subscriber not connected to the first telecommunication terminal finds himself/herself in a waiting position. A third example is what is known as a “secretary function”, whereby initially a link exists between a first and a second telecommunication terminal and between the first and a third telecommunication terminal. Subsequently, the two existing links are converted into a link between the second and the third telecommunication terminal.

Problems also arise if technologically dissimilar telecommunication networks are interconnected, for example if a link in a first telecommunication network can be controlled by influencing segments from which the link is built up, while in a second telecommunication network the connection is viewed as a whole and essentially controlled from the endpoints. An example of the first telecommunication network is a telecommunication network which operates according to the TDM method and was therefore derived from the conventional switching of telephone calls. The term “connection-oriented telecommunication network” is known for such a network. An example of the second telecommunication network, on the other hand, would be a telecommunication network operating according to the “Internet Protocol”, that is a network derived from conventional data transmission. The term “package-switching telecommunication network” is also commonly used for such a data network. The Real Time Transport protocol (abbreviated to RTP protocol) is also worthy of mention in this context.

Since voice can also be viewed as a data stream, data is transported over TDM networks and voice over IP networks. This is one reason why technologically dissimilar telecommunication networks are substituted for one another or interconnected. This fusion of telecommunication networks of different types is also known by the term “convergence”.

Telecommunication networks which are essentially constructed from TDM components and are interlinked to IP networks operate for example in compliance with the standard for Bearer Independent Call Control and are known in abbreviated form as BICC networks.

The differing principles which the individual telecommunication networks comply with lead to problems when they are interconnected. This is one reason why special functions are required for networks to work together across technological boundaries. These functions are also designated “interworking functions”.

In known network models for voice/data services in packet-switched data networks, as described for example in the ITU documents Q 1901 and Q 1902, there is provided at each interface between different networks an interworking function, by means of which the bearer channels are switched between the networks. This interworking function is provided at each internetwork interface, even if the two networks are technologically of the same type and an interworking function may not be required for technical reasons or if a bearer channel is routed across multiple networks. These interworking functions usually result in delays in the conversion of data and in some cases also in losses of data. In order to prevent or largely curb these negative effects, substantial outlays on equipment are required in order to implement such an interworking function.

### SUMMARY OF THE INVENTION

An advantage of the present invention is directed to a procedure for straight forward controlling of a link in a telecommunication network and in particular between at least a first and a second telecommunication terminal.

This is achieved by an inventive method:

wherein a model of this link is generated in a programmable computer,

wherein this model is set to an initial status assigned to the status of this link,

wherein when first measures which are implemented in the telecommunication network in relation to this link are carried out, assigned status changes are triggered in the model,

wherein second measures are implemented in the model, and

wherein, with the aid of the behavior of the model based on a second measure, a decision is made as to whether this second measure, a different measure or no measure is implemented in the telecommunication network.

In the present method, the information which relates to the status of a link between two telecommunication terminals is also available directly in a link model. Accordingly, it is possible to implement in advance in the link model a measure which is to be implemented in the telecommunication network and to derive a further course of action from the behavior of the link model. At the same time, a measure implemented in the link model can also change the status of the model. The link in the telecommunication network, by contrast, is not influenced by the measure. If the behavior of the link model shows that an implemented measure would have a negative effect on the link, this measure is cancelled again in the link model, for example, and is not implemented at all in the telecommunication network.

It is also pointed out in this context that distinguishing between first and second measures within the framework of the disclosure is not used to indicate a sequential order but to categorize measures.

It is also conceivable that the present model will not be used to test a measure to be implemented but will serve to derive in general a further course of action from a measure which is implemented in the link model. This further course of action will not necessarily also result in measures in the telecommunication network. An advantage here is that the link in the telecommunication network remains unaffected by it.

A further advantage lay in that the behavior of the link model can be evaluated relatively quickly since, in order to do this, the information relating to a link and which is present in different modules and memory areas does not have to be evaluated directly. This information is already present in the link model. This procedure is also particularly advantageous if this information is only available distributed across the telecommunication network. Direct analysis would at the same time entail a high level of data traffic between the individual modules distributed across the telecommunication network, which can in this way advantageously be avoided.

In the method according to the invention the control of a link may also comprise measures in which either a bearer channel of the link, a signaling channel of the link or both are influenced. The measures and the network elements to which they relate depend to a high degree on the principles according to which a telecommunication network operates and on the technology used. They do not therefore have to relate to bearer and signaling channel.

The present advantages of the invention are also achieved by a variant of the method according to the invention,

wherein a first set of measures for achieving a defined link status relative to the two endpoints has to be implemented in the first telecommunication network and

wherein a second set of measures for achieving the same link status relative to the two endpoints has to be implemented in a second telecommunication network,

wherein a model of this link of the second telecommunication network is generated in a programmable computer,

wherein this model is set to an initial status assigned to the status of this link,

wherein, when first measures which are implemented in the first or second telecommunication network in relation to this link are carried out, assigned status changes are triggered in the model,

wherein second measures of the first or second telecommunication network are implemented and

wherein with the aid of the behavior of the model based on a second measure a measure is derived and optionally implemented in the first and/or telecommunication network.

Different telecommunication networks do not necessarily operate according to the same principles so that different measures in the individual telecommunication networks require the through connecting of a call even if the result in relation to the endpoints is essentially the same. In the cited example, it cannot therefore generally be seen by the users of a telecommunication terminal which internal states and switching measures have resulted in the call being through-connected and how the telecommunication network to which the telecommunications terminals are connected operates.

As a result of the interconnection of different telecommunication networks, special safeguards are required in order to leave the behavior relative to the endpoints of a link unchanged although different measures are required in the various telecommunication networks to achieve this.

The invention solves this problem in a particularly advantageous way since here a second measure of a first or second telecommunication network is implemented in the link model and, with the aid of the behavior of the link model based on this measure, a decision is made as to whether a second measure is implemented in the first and/or second telecommunication network.

It is advantageous

if the second measure which is implemented in the link model relates to a section of the link and

if from the behavior of the link model based on this measure, a measure is implemented in the telecommunication network which measure is related to one or both endpoints of the link.

It is possible in this way to map a widespread approach in the design of TDM networks and which relates to sections of a link in a telecommunication network onto an approach in which the main focus is placed on the whole link and its endpoints.

It is also advantageous

if the second measure which is implemented in the link model relates to one or both endpoints of the link and

if, from the behavior of the link model based on this measure, a measure which relates to a section of the link is implemented in the telecommunication network.

With this variant, measures which relate to an endpoint of the link are mapped onto measures which influence a section of the link. For example, the behavior of a typical packet-switching data network which can be influenced significantly at the endpoints of a link is mapped here on to the principles of a classic TDM network in which the link between two telecommunication terminals can be controlled above all by influencing sections of the link.

A particularly advantageous variant of the method according to the invention is given in an embodiment

wherein the link model is formed by objects and their links,

wherein, when first measures are carried out, assigned objects are generated and/or deleted in a programmable computer and/or

wherein, when first measures are carried out, multiple assigned objects are connected or disconnected from one another and/or

wherein, when first measures are carried out, assigned parameters used in the model are changed.

At the same time that the object is generated, the parameters used in this object are generally also initialized. The same also applies to the linking of multiple objects insofar as parameters are assigned to this link. Initializing and implementing changes in both the telecommunication network and the link model ensures that the structure of the link model and the values of the parameters used therein reflect the status of a link in a telecommunication network. Objects and their links can, of course, also be deleted again where this is planned and the assigned measure implemented in the telecommunication network.

The object-oriented solution proposal is particularly advantageous since the overview of the model obtained can be preserved comparatively easily. Furthermore, expansions and modifications are relatively easy to implement.

It is also advantageous if a status/event table is generated as a link model in a programmable computer. In addition to the object-oriented approach, it is also conceivable for the states and transactions occurring in a link model to be displayed in the form of a status/event matrix. The comparatively rapid evaluation of a transaction is advantageous.

An advantageous variant is also obtained

if a model of a send channel is provided as an object and/or

if a model of a receive channel is provided as an object and/or

if a model of a switching element for connecting and disconnecting a receive channel from a send channel and vice versa is provided as an object and/or

if a model of a signal generator is provided as an object, and a send channel of this object is linked to a receive channel of another object and/or

if a model of a signal receiver is provided as an object and a receive channel of this object is linked to the send channel of another object and/or

if a model of a combined signal source/sink is provided as an object and a send channel of this combined signal source/sink is linked to a receive channel of another object and/or a receive channel of this combined signal source/sink is linked to a send channel of another object and/or

if a conversion element for converting the address of a telecommunication terminal from one address format into another address format is provided as an object.

Send and receive channels, as well as combined send/receive channels, are typical components in a telecommunication network. The same also applies to signal generators and signal receivers.

An example of a signal generator is, for example, a tone generator which is suitable for emitting ringing tones. However, the invention also covers any other signal source, including, for example, also a recorded announcement service in an exchange.

Signal receivers refer for example to tone receivers which are capable of evaluating a signal in accordance with the Dual-Tone Multifrequency standard (abbreviated to DTMF standard). As in the case of the signal generator, the invention covers not only devices for processing tones, however, but also for example voice-processing systems.

A typical example of a combined signal source/sink is a telecommunication terminal which generally comprises both a microphone and a loudspeaker.

Typical in a telecommunication network are also switching elements which are capable of connecting and disconnecting the individual units. In this way, for example, the send channel of a tone generator can be linked to the receive channel of a telecommunication terminal in order thus to signal an idle or busy line. After the call has been through-connected, the receive channel of the telecommunication terminal is then switched by the tone generator to the send channel of the linked telecommunication terminal.

It is also conceivable for a conversion element to be used which converts the address of a telecommunication terminal from one address format to another address format. This is necessary in particular if different address formats are used in one telecommunication network, or if different telecommunication networks in which differing address formats are used are interconnected.

A particularly advantageous variant is achieved in an embodiment

wherein a bearer independent call control network is provided as a telecommunication network,

wherein a functionality of a gateway serving node, in particular the element pertaining to a gateway bearer interworking function, is integrated in the model and/or

wherein a functionality of an interface serving node is integrated in the model and/or

wherein a bearer interworking function is integrated in the model and/or

wherein a gateway bearer interworking function is integrated in the model.

A common approach to operating conventional TDM networks whereby a link in a telecommunication network is controlled substantially by influencing sections of this link has led inter alia, for example in the case of the standardization of bearer independent call control networks, to specification of a large number of different network elements. The method according to the invention offers a simple facility for integrating these elements in a model and thus for focusing their functionality on one or more points in the telecommunication network.

The advantage of the invention is also achieved in a method of the type specified in the introduction, wherein the telecommunication network is built up of technologically differing subnetworks, and for one subnetwork in particular a bearer independent call control network is provided and

wherein a functionality of a gateway serving node, in particular the part supported by a gateway bearer interworking function, is integrated in a functionality of an interface service node.

The gateway service nodes distributed for example in a Bearer Independent Call Control network (abbreviated to BICC network), are shifted, particularly with regard to the gateway bearer interworking functions, to the interface service nodes, i.e. to the endpoints of the link. Resources which would be necessary in an arrangement according to the prior art are thus preserved. The telecommunication network can in this way achieve for example both a higher level of fail-safe protection for a link and improved data-throughput times.

It is advantageous here

if the bearer-channel switching is routed via a first bearer interworking function and/or a second bearer interworking function.

In this embodiment of the invention further gateway bearer interworking functions are not compulsorily required and data conversion does not therefore take place frequently as is the case with the prior art. A further bearer interworking function can optionally be dispensed with, provided the corresponding telecommunication terminal can be connected directly, that is without an interworking function, to the telecommunication network. A reduction in data conversion also results inter alia in better data-throughput times and higher fail-safe protection of the link.

A particularly advantageous variant of the invention is also obtained in a method

wherein a functionality of a gateway serving node, in particular the element pertaining to a gateway bearer interworking function and/or

wherein a functionality of an interface serving node and/or

wherein a bearer interworking function and/or

wherein a gateway bearer interworking function is mapped in a model of a link in the telecommunication network.

A large number of different network elements can in this way be integrated in a model of a link and optionally dispensed with. Their functionality is thus focused on one or more points in the telecommunication network. Higher fail-safe protection for a link and better data-throughput times, for example, can also be achieved here by the telecommunication network.

The previously mentioned possible embodiments and their advantages also apply to this link model. The link model in this case can be formed from both objects and their connections and a status/event table.

This advantage of the invention is also achieved by means of an arrangement which is set up in order to implement the method according to the invention,

wherein the arrangement comprises a programmable computer which is suitable for storing and administering a model of a link in a telecommunication network,

wherein means exist in the model for triggering changes of state, the changes of state being assigned to first measures which are implemented in the telecommunication network,

wherein means exist in the model for implementing second measures,

wherein the arrangement comprises means for evaluating the behavior of the model based on a second measure and means for deciding whether this second measure, another measure or no measure is implemented in the telecommunication network, and

wherein means exist for implementing a measure in the telecommunication network, taking the model as a starting point.

It is favorable here that the arrangement comprises in part known and proven components. In other respects, the advantages mentioned of the method according to the invention also apply in equal measure to the arrangement according to the invention.

The advantage of the invention is finally also achieved in an arrangement which is set up in order to implement the method according to the invention, and

wherein an end-to-end logical link exists between a first interface serving node and a second interface serving node,

wherein the first interface serving node is linked to first bearer interworking functions and/or

wherein the second interface serving node is linked to second bearer interworking functions.

In contrast to a solution according to the prior art, in this variant an end-to-end logical link exists between the interface serving nodes. The gateway bearer interworking functions assigned to the gateway serving nodes are as a rule no longer required here since their functionality is integrated in the interface serving nodes. A gateway serving node can therefore optionally be omitted altogether. The result therefore is a network configuration with fewer network elements and a technically simpler structure.

### BRIEF DESCRIPTION OF THE SEVERAL VIEWS OF THE DRAWINGS

The novel features believed characteristic of the invention are set out in the claims below. The invention itself, however, as well as other features and advantages thereof, are best understood by reference to the detailed description, which follows, when read in conjunction with the accompanying drawings. The invention is explained in detail by reference to an embodiment shown in the Figures, said embodiment relating to an example of a link model consisting of multiple objects linked to one another. Furthermore, the advantages of the invention will be shown by reference to a network configuration of a BICC network. The figures comprise:

FIG. 1 which depicts an example of a link model in an initial state;

FIG. 2 which depicts an example of a link model upon presentation of an idle tone to a telecommunication terminal;

FIG. 3 depicts an example of a link model upon transmission of the first call digits of a telecommunication terminal;

FIG. 4 depicts an example of an arrangement for transmitting data between link models which are distributed across the telecommunication network;

FIG. 5 depicts an example of a link model upon presentation of a ringing tone to a telecommunication terminal;

FIG. 6 depicts an example of an arrangement for linking two telecommunication terminals via telecommunication networks of different types;

FIG. 7 depicts a network configuration according to the prior art, wherein a link is established between two telecommunication terminals across several technologically differing telecommunication networks;

FIG. 8 depicts a network configuration according to the invention, wherein a link is established between two telecommunication terminals across several technologically differing telecommunication networks;

### DETAILED DESCRIPTION OF THE INVENTION

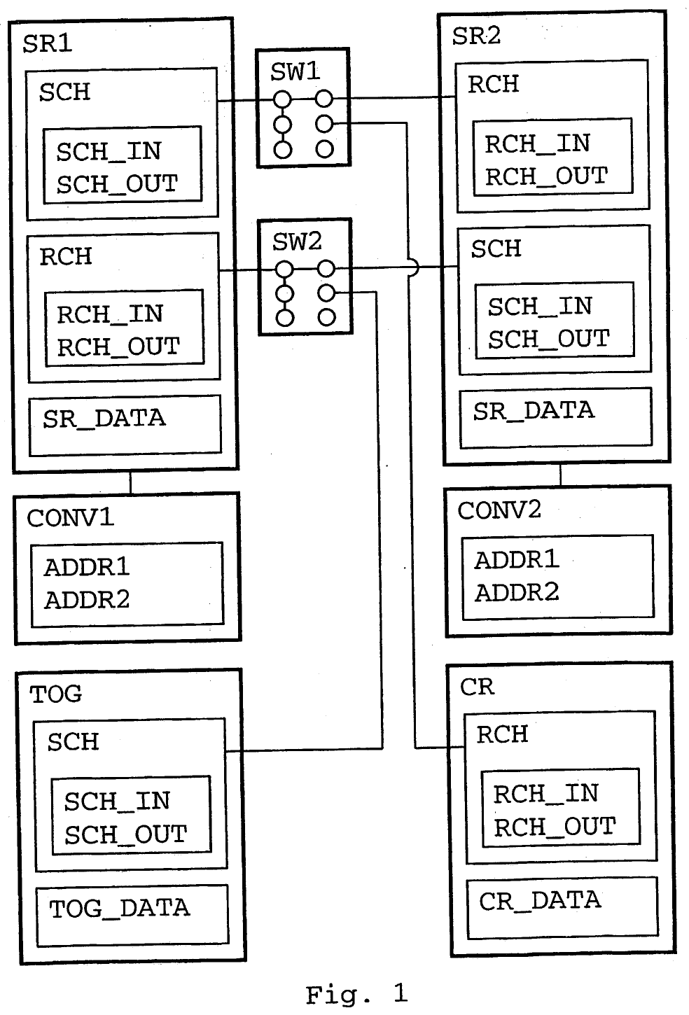

FIG. 1 depicts an example of a link model in an initial state, said link model comprising a first combined signal source/sink SR1, a second combined signal source/sink SR2, a first switching element SW1, a second switching element SW2, a first conversion element CONV1, a second conversion element CONV2, a tone generator TOG and a signal receiver CR.

Both the first combined signal source/sink SR1 and the second combined signal source/sink SR2 represent in the example shown the endpoints of a link in a telecommunication network and are distinguished in having a substantially same type of structure. They each comprise a send channel SCH, a receive channel RCH and a supplementary data area SR_DATA.

The tone generator TOG comprises a send channel SCH and a supplementary data area TOG_DATA. Analogously, the signal receiver CR comprises a receive channel RCH and likewise a supplementary data area CR_DATA.

All send channels SCH in the objects shown comprise an input register SCH_IN and an output register SCH_OUT. Analogously, all receive channels RCH each comprise an input register RCH_IN and an output register RCH_OUT.

For the input register of the send channel SCH_IN, the values ready-to-send Sready, tone information Tone and idle state Idle are possible in this example. For the input register of the receive channel RCH_IN the values ready-to-receive Rready and idle state Idle are possible. For the output register of the send channel SCH_OUT, the values ready-to-receive Rready and idle state Idle and for the output register of the receive channel RCH_OUT, the values ready-to-send Sready, tone information Tone and idle state Idle are also provided in this example.

In the example, changes in the values of the output registers are detected and used in evaluating the behavior of the link model. Further measures are optionally derived from these changes and are implemented in a telecommunication network. In this process, a table can be created for example object-specifically, in which table a measure to be implemented in a telecommunication network is assigned to a change in an output register. If no assignment is present, no measure is implemented. Multiple assignments, as well as assignments specific to different telecommunication networks, are also conceivable.

Both the first conversion element CONV1 and the second conversion element CONV2 comprise in the example shown of a first address field ADDR1 and a second address field ADDR2. Multiple address fields, and/or supplementary data fields are, however, also conceivable.

The first switching element SW1 and the second switching element SW2 are of the same configuration and comprise three connections, wherein the first connection can be linked either to the second or to the third connection. In addition, a switching state in which no connection is linked to another is also possible. Furthermore, in the example shown no account was taken of whether the connections involved were input or output terminals. Configurations which deviate from those shown in the Figure are of course also conceivable. The illustration of the switching elements must also be seen as merely symbolic with regard to missing data fields. Switching elements can also be omitted altogether and replaced by flexible direct links between the objects.

The individual objects are linked to one another as follows:

The send channel SCH of the first combined signal source/sink SR1 is linked to the first connection of the first switching element SW1, and the receive channel RCH of the first combined source/sink SR1 is linked to the first connection of the second switching element SW2. Analogously, the second connection of the first switching element SW1 is linked to the receive channel RCH of the second combined signal source/sink SR2, and the second connection of the second switching element SW2 is linked to the send channel SCH of the second combined signal source/sink SR2.

There also exist a link between the third connection of the first switching element SW1 and the receive channel RCH of the signal receiver CR and a link between the third connection of the second switching element SW2 and the send channel SCH of the tone generator TOG.

Both in the first switching element SW1 and in the second switching element SW2 the first connection is linked to the second connection in each case so that a bidirectional link exists between the first combined signal source/sink SR1 and the second combined signal source/sink SR2.

In addition, the first combined signal source/sink SR1 is linked to the first conversion element CONV1, and the second combined signal source/sink SR2 is linked to the second conversion element CONV2.

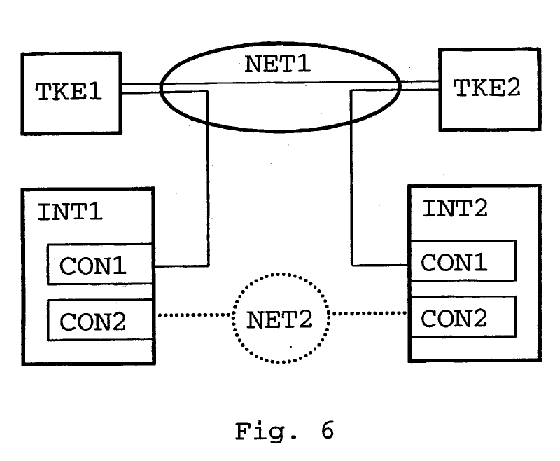

FIG. 6 shows an example of an arrangement for linking two telecommunication terminals via telecommunication networks of different types.

The arrangement comprises a first telecommunication terminal TKE1 and a second telecommunication terminal TKE2, a first telecommunication network NET1 and a second telecommunication network NET2 and a first and a second interface module INT1 and INT2. The first and second interface modules INT1 and INT2 are of the same configuration and each comprise a first connection CON1 and a second connection CON2. An interface module can also comprise further units, in particular switching units, which can relate to both the first telecommunication network NET1 and the second telecommunication network NET2.

The first telecommunication network NET1 operates in the example shown according to the Real Time Transport protocol (abbreviated to RTP protocol). Another standard, in particular a standard for packet-switched data transmission, is however also conceivable.

The second telecommunication network NET2 operates in the arrangement shown according to the Time Division Multiplex method (abbreviated to TDM method), alternatives also being conceivable here. The second telecommunication network NET2 may also exist only as a virtual network.

The individual modules are linked to one another as follows:

The first telecommunication terminal TKE1 is linked via the first telecommunication network NET1 with the first connection CON1 of the first interface module INT1. Analogously, the second telecommunication terminal TKE2 is linked via the first telecommunication network NET1 with the first connection CON1 of the second interface module INT2. In addition, a link exists via the second telecommunication network NET2 between the second connection CON2 of the first interface module INT1 and the second connection CON2 of the second interface module INT2. The first telecommunication terminal TKE1 is also linked directly to the second telecommunication terminal TKE2 via the first telecommunication network NET1.

In the Figures, virtual objects are shown by a broken line and physically existing objects by a solid line. Per the example embodiment of FIG. 6, the second telecommunication network NET2 is thus assumed to be virtual.

A further assumption in respect of the example is that user data is exchanged on the direct link between the first and the second telecommunication terminals TKE1 and TKE2, and signaling data is exchanged on the remaining links. These assumptions are not, however, mandatory for the method according to the invention.

The function of the example embodiment of FIGS. 1 to 6 is as follows. For the sake of clarity, simplifications have been made compared with an actual possible implementation:

The first telecommunication terminal TKE1 and the second telecommunication terminal TKE2 are linked to the first telecommunication network NET1 which operates in compliance with the RTP standard. It is essential for these networks that a link within this network is viewed in its entirety and controlled from the endpoints. The second telecommunication network NET2, which is based on the TDM method, contrasts with this. In this network a link generally comprises several sections which can be influenced separately from one another. This influence does not generally emanate exclusively from the endpoints. Since between the first and second telecommunication terminals TKE1 and TKE2 a link of the signaling channel is switched via telecommunication networks which operate according to different principles, the first and second interface modules INT1 and INT2 are provided. These interface modules enable the interconnection of telecommunication networks of different types. This function is also known as “interworking”. The bearer channel is for example switched according to a method known for packet-switched data networks.

A link model is generated in this example in both the first interface module INT1 and the second interface module INT2, and said link model can receive signals via the first connection CON1 and the second connection CON2 from the telecommunication networks connected thereto and can also emit signals to these networks. The aim of these link models is to establish between the first and second telecommunication terminals TKE1 and TKE2 a virtual link which behaves just as a link in a homogeneous telecommunication network operating according to the RTP standard behaves. For simplification purposes, only the generation of the link model in the first interface module INT1 upon establishment of the connection between the two telecommunication terminals is examined. It should be pointed out that the link model is not shown in FIG. 6.

When a request is made to establish a connection between a first and a second telecommunication terminal TKE1 and TKE2, the request is signaled from the first telecommunication network NET1 via the first connection CON1 of the first interface module INT1 to the first interface module INT1 and forwarded from there to the second telecommunication network NET2. Conversion of the information to be transmitted can be carried out to this end in the first interface module INT1. Resources are allocated in the second telecommunication network NET2 according to the network logic, said resources also being mapped in the link model. A link model as per FIG. 1 is therefore generated in the first interface module INT1. However, by way of derogation from FIG. 1, the first switching element SW1 connects in the initial state the send channel SCH of the first combined signal source/sink SR1 to the signal receiver CR, and the second switching element SW2 connects the receive channel RCH of the first combined signal source/sink SR1 to the tone generator TOG. As well as configuring the link model in one step, it is also conceivable for the link model to be configured in several steps, wherein only those objects which are absolutely necessary in the current state are generated.

In addition, the address of the first telecommunication terminal TKE1 is entered in the first address field ADDR1 of the first conversion element CONV1. As well as the straightforward address information, further data can also be entered via the first telecommunication terminal TKE1, for example data about the set-up and mode of operation of the first telecommunication terminal TKE1.

The first telecommunication terminal TKE1 is designed in our example to be equipped to generate a dial tone. In a conventional TDM network this is generally not the case since the dial tone is generated in an exchange and transmitted to the telecommunication terminal. In order that resources are not allocated unnecessarily in a telecommunication network operating according to the RTP standard, instead of the dial tone itself only information about the dial tone is transferred to the telecommunication terminal. This information can include for example the pitch, repetition rate and switch-on ratio. However, the transfer of a dial tone as a data stream is of course also conceivable in an RTP network.

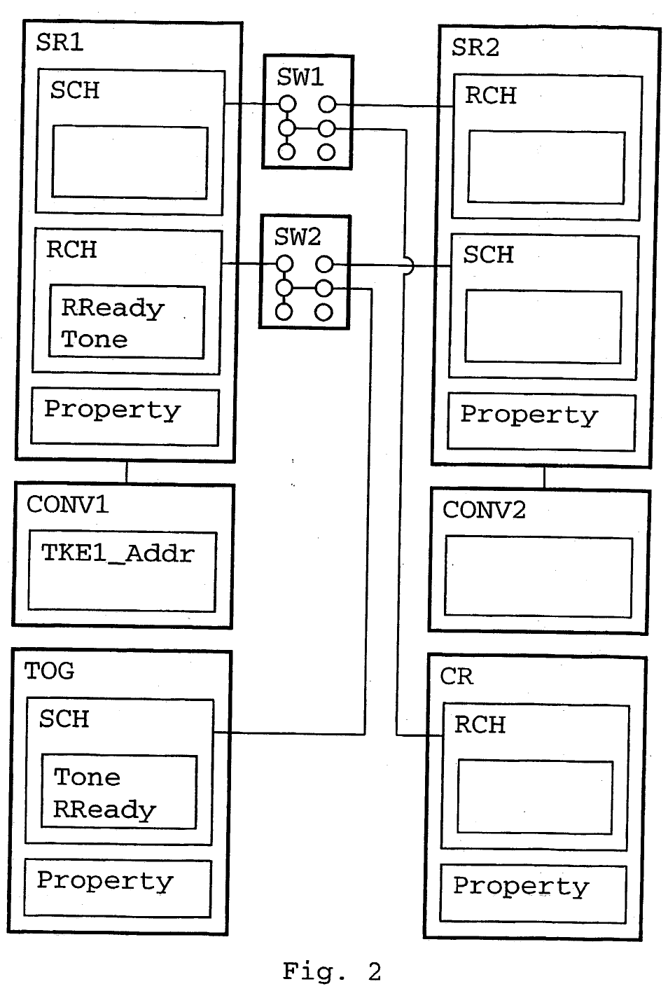

The tone information Tone for generating a dial tone is now entered in the input register of the send channel SCH_IN of the tone generator TOG. As a next step, this data is transferred to the output register of the receive channel RCH_OUT of the first combined signal source/sink SR1. Analogously, the ready-to-receive value Rready is entered in the input register of the receive channel RCH_IN of the first combined signal source/sink SR1 and transferred to the tone generator TOG. There, this value is transferred to the output register of the send channel SCH_OUT. The current status of the arrangement can also be seen from FIG. 2.

FIG. 2 additionally indicates that information about a property of the physical object Property represented by an object in the link model is entered in the supplementary data area SR_DATA of the first combined signal source/sink SR1, the supplementary data area SR_DATA of the second combined signal source/sink SR2, the supplementary data area CR_DATA of the signal receiver CR and the supplementary data area TOG_DATA of the tone generator TOG. This can for example take place on initialization.

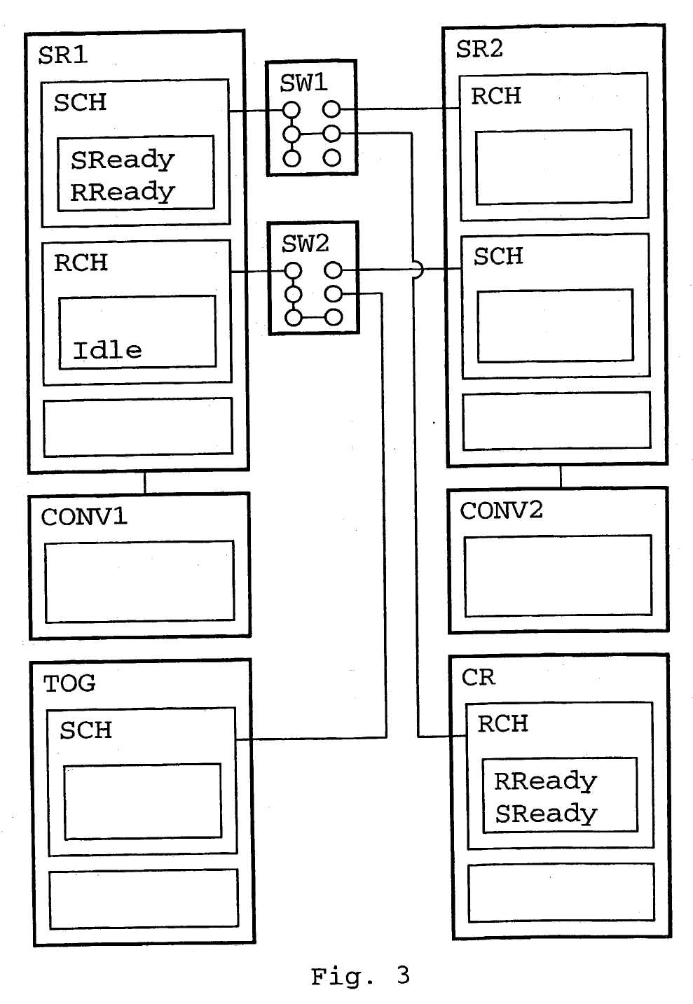

Furthermore, all data fields which were not changed when a change of state occurred are shown as blank in FIG. 2. This also applies to FIGS. 3, 4 and 5. Nevertheless, data can of course be included in the fields concerned.

The creation of the dial tone in the link model is now complete. In order to evaluate the behavior of the link model, the output registers of the respective objects are examined after each cycle in which an input signal to the link model is processed. If their value was changed relative to the start of the analysis cycle, then a message to this effect is optionally sent to the unit in the telecommunication network. If the value was not changed, no message is sent.

In our example, the change in the output register of the receive channel RCH_OUT of the first combined signal source/sink SR1 results in a signal being sent to the first telecommunication terminal TKE1 in the first telecommunication network NET1 to generate the dial tone for example in the loudspeaker of the telephone handset. This is therefore a measure which was derived based on the behavior of the link model arising out of another measure, namely the signaling from the first telecommunication network NET1 to the first interface module INT1 to create a dial tone. In order to be able to send the corresponding message to the first telecommunication terminal TKE1, the address of said telecommunication terminal is read out from the first data field ADDR1 of the first conversion element CONV1. By contrast, no signal to the second telecommunication network NET2 is assigned to the change in the output register of the receive channel RCH_OUT of the tone generator TOG.

The call number of the second telecommunication terminal TKE2 is now keyed in by the user of the first telecommunication terminal TKE1 with the aid of a numerical array. This call number is sent via the first telecommunication network NET1 to the first interface module INT1 and fed into the link model. To this end, the value ready-to-send Sready is entered in the input register of the send channel SCH_IN of the first combined signal source/sink SR1 and transferred to the output register of the receive channel RCH_OUT of the signal receiver CR. Analogously, the value ready-to-receive Rready is entered in the input register of the receive channel RCH_IN of the signal receiver CR and transferred to the output register of the send channel SCH_OUT of the first combined signal source/sink SR1 .

The switchover of the second switching element SW2 to the third switching state, in which third switching state no connection is linked to another, is assigned to this change of state. The result is therefore that the tone generator TOG is no longer linked to the first combined signal source/sink SR1. The idle-status value Idle is therefore entered in the output register of the receive channel RCH_OUT of the first combined signal source/sink SR1. In our example, the change in the output register of the receive channel RCH_OUT of the first combined signal source/sink SR1 leads to a signal being sent to the first telecommunication terminal TKE1 in the first telecommunication network NET1 to switch the idle tone off again. The temporary state of the link model is reproduced in FIG. 3.

All further transmitted digits are passed in sequence through the link model transparently and are transmitted to the second telecommunication network NET2. It is also conceivable for the current state of the link model to be evaluated in order to determine how the digits should be passed through and transmitted without producing a change of state of the link model. After the call number has been input fully, the link is switched between the first telecommunication terminal TKE1 and the second telecommunication terminal TKE2. The first and the second switching elements SW1 and SW2 are set in the link model also such that the send channel SCH of the first combined signal source/link SR1 is linked to the receive channel RCH of the second combined signal source/link SR2, and the receive channel RCH of the first combined signal source/link SR1 is linked to the send channel SCH of the second combined signal source/link SR2.

At this time, a second link model as per FIG. 1 is also generated in the second interface module INT2, the first switching element SW1 being set to the third switching state, i.e. no other object is linked to the first combined signal source/sink SR1. The second switching element SW2 by contrast links the tone generator TOG to the first combined signal source/link SR1.

Messages are exchanged between the two link models in the two interface modules via the second telecommunication network NET2 so that both link models reflect the status of the link between the first and the second telecommunication terminals TKE1 and TKE2. The exchange of messages between the individual components of a link model distributed in a telecommunication network or between different entities of a link model can be carried out for example using a so-called tunnel method.

A signal is sent from the second telecommunication network NET2 to the second link model of the second interface module INT2 that the ringing signal should be presented to the second telecommunication terminal TKE2. In conformity with the principles already described, the behavior of the second link model is evaluated. As a consequence of this, a signal is sent via the first telecommunication network NET1 that the ringing signal should be activated by the second telecommunication terminal TEL2. Furthermore, a corresponding message is transmitted from the second link model of the second interface module INT2 via the second telecommunication network NET2 to the first link model of the first interface module INT1.

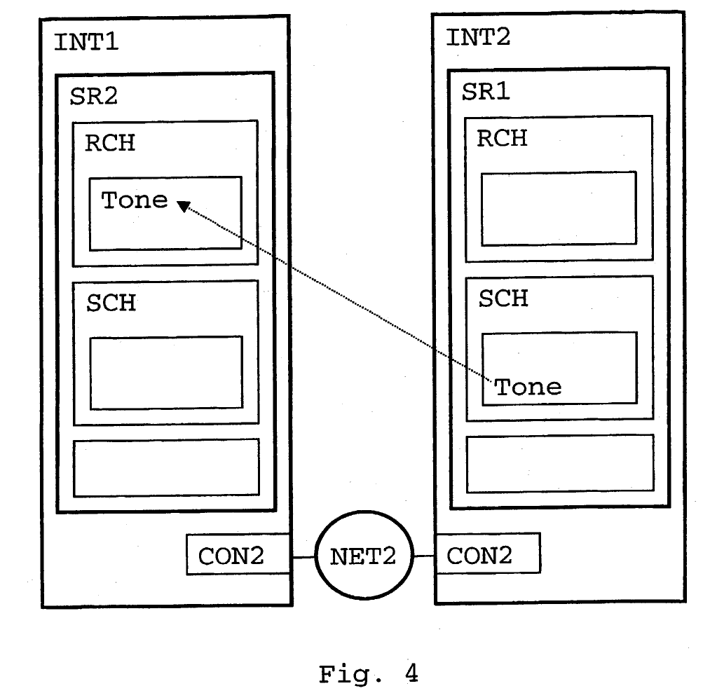

This procedure is shown in FIG. 4, the link models in the first and second interface modules INT1 and INT2 being reduced to the most essential details. The transmission of the tone information Tone from the output register of the receive channel SCH_OUT of the first combined signal source/sink SR1 in the second interface module INT2 to the input register of the receive channel RCH_IN of the second combined signal source/sink SR2 in the first interface module INT1 is indicated by a broken arrow.

In the first link model of the first interface module INT1, the tone information Tone in respect of the ringing signal is now entered in the input register of the send channel SCH_IN of the second combined signal source/sink SR2 and transferred to the output register of the receive channel RCH_IN of the first combined signal source/sink SR1. The transfer of the tone information to the first telecommunication terminal TKE1 via the first telecommunication network NET1 is assigned to this change of state in the link model. Consequently, the ringing signal is also generated in the first telecommunication terminal TKE1, for example with the aid of a loudspeaker in a telephone handset.

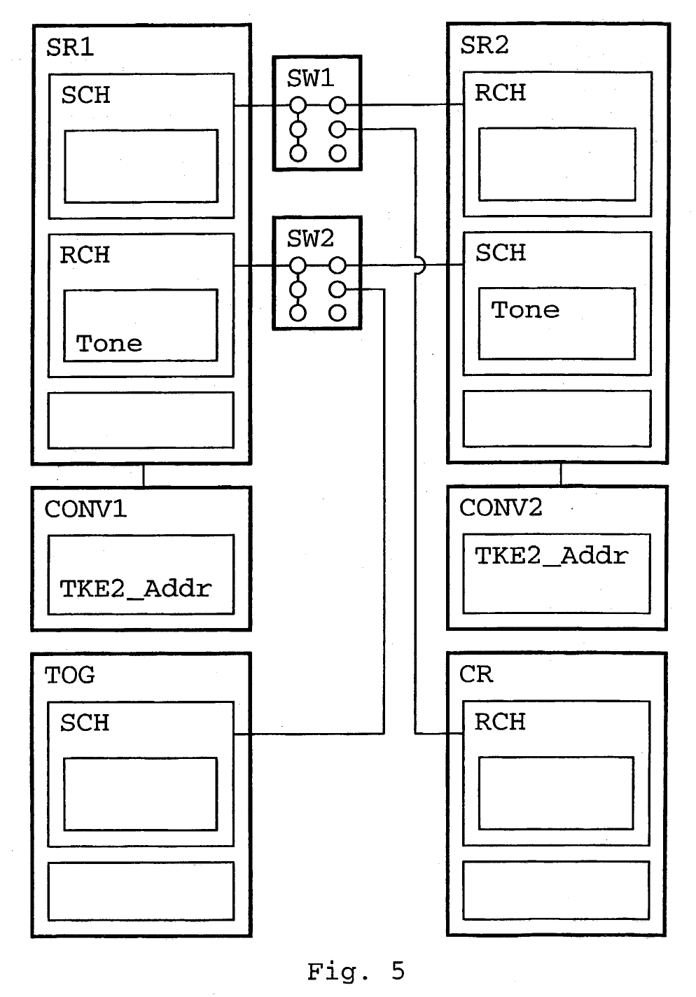

The lifting of the telephone handset at the second telecommunication terminal TKE2 is also processed in a corresponding way so that with the aid of the first and the second interface modules INT1 and INT2 the call is placed through between the first and second telecommunication terminals TKE1 and TKE2. In this process, the address of the second telecommunication terminal TKE2 is transmitted to the first link model in the first interface module INT1 and entered there in the first address field ADDR1 of the second conversion element CONV2 and in the second address field ADDR2 of the first conversion element CONV1. The status of the link model is shown in FIG. 5.

The above approaches naturally apply equally to both the bearer channel and the signaling channel. In particular, the bearer channel can, as shown, be routed over a different pathway from the signaling channel.

The method according to the invention also has for example the advantage that resources which are available in the second telecommunication network NET2 can be utilized. If the telecommunication network in this case is for example a telecommunication network which operates according to a TDM method, available and tested services and/or algorithms, for example the switching of conference calls, call waiting, call forwarding and the like, can optionally be used, even if these services are not available in the first telecommunication network NET1. Components of the second telecommunication network NET2, such as switching nodes for example are thus embedded in the first telecommunication network NET1. However, this embedding cannot be detected or can be detected only to a limited extent within the second telecommunication network NET2. No changes, or only slight changes, are therefore required in this regard in the second telecommunication network NET2. Technologically dissimilar telecommunication networks can therefore be interconnected advantageously with the aid of the method according to the invention.

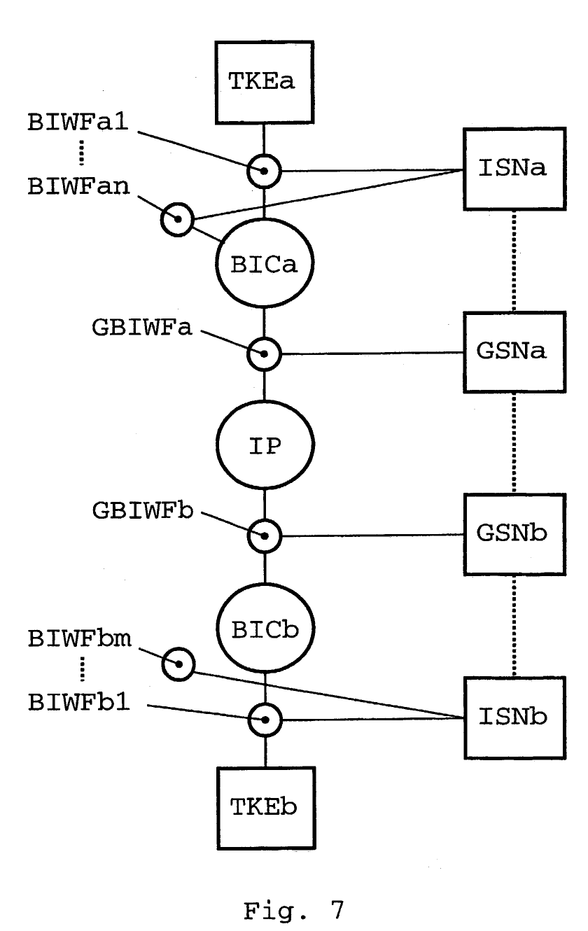

FIG. 7 shows a network configuration according to the prior art, wherein a link is established between two telecommunication terminals over multiple technologically different telecommunication networks. The abbreviations contained in the Figures correspond to the names standardized for a Bearer Independent Call Control network (abbreviated to BICC network), as set out in ITU-T standard TRQ.2140 which is available on the Internet.

FIG. 7 comprises a first and a second telecommunication terminal TKEa and TKEb, a first and a second telecommunication network BICa and BICb, operating according to the BICC method and a third IP telecommunication network operating for example according to the Internet Protocol. Also contained in the Figure are a first and a second interface serving node ISNa and ISNb and a first and a second gateway serving node GSNa and GSNb. Also shown in the Figure are first bearer interworking functions BIWFa1 to BIWFan and second bearer interworking functions BIWFb1 to BIWFbm and a first and a second gateway bearer interworking function G-BIWFa and G-BIWFb.

The individual functions are linked to one another as follows. The first telecommunication terminal TKEa is connected via the first bearer interworking functions BIWFa1 to the first telecommunication network BICa. Analogously, the second telecommunication terminal TKEb is linked via the second bearer interworking functions BIWFb1 to the second telecommunication network BICB. The remaining first bearer interworking functions BIWFa2 to BIWfan are also linked to the first telecommunication network BICa, but are shown only symbolically. Likewise, the remaining second bearer interworking functions BIWFb2 to BIWFbm are also linked to the second telecommunication network BICb and are also shown only symbolically.

Connecting a telecommunication terminal TKE to a telecommunication network via a bearer interworking function BIWF is not mandatory. It is of course also conceivably the case that the telecommunication terminal TKE and the telecommunication network are technologically of the same type and can be connected to one another directly. A bearer interworking function BIWF is in this case not absolutely necessary.

In addition, a link exists between the first and the second telecommunication networks BICa and BICb via the first gateway bearer interworking function G-BIWFa, the third IP telecommunication network IP and the second gateway bearer interworking function G-BIWFb.

n links exist from the first interface serving node ISNa to each first bearer interworking function BIWFa1 to BIWfan, and m links exist from the second interface serving node ISNb to each second bearer interworking function BIWFb1 to BIWFbm. The first gateway serving node GSNa is linked to the first gateway bearer interworking function G-BIWFa, and the second gateway serving node GSNb is linked to the second gateway bearer interworking function G-BIWFb.

In addition, a logical link is indicated by a broken line from the first interface serving node ISNa via the first gateway serving node GSNa and the second gateway serving node GSNb to the second interface serving node ISNb.

The function of the arrangement shown in FIG. 7 is as follows:

At the network boundaries at least the address of a telecommunication terminal TKE is converted with the aid of a bearer interworking function G-BIWF from a first address format which is used in a telecommunication network to a second address format which is used in another telecommunication network. The function of a bearer interworking function G-BIWF therefore covers the function of a dynamic “network address translation” (NAT) or of a “network address port translation” (NAPT). This procedure requires that connection-relevant data must be stored in the IP network. If a fault occurs in a bearer interworking function G-BIWF, then the connections running via said function are terminated. The use of fail-safe or fault-tolerant and therefore technically costly components is therefore required. In addition, through the bearer interworking functions G-BIWF delays occur in data transmission as well as optionally bottlenecks between the individual telecommunication networks.

In the case of the method according to the invention, by contrast, the functionality of a gateway serving node GSN, in particular the element pertaining to a gateway bearer interworking function G-BIWF, is integrated in the interface serving node ISN. Both the gateway bearer interworking functions G-BIWF and optionally the gateway serving nodes GSN can therefore be omitted. The user information is in this case carried from the first telecommunication terminal TKEa via the incoming bearer interworking function or first bearer interworking function BIWFa1 into the first telecommunication network BICa, transparently passed to the second telecommunication network BICb and there transmitted via the outgoing bearer interworking function or second bearer interworking function BIWFb1 to the second telecommunication terminal TKEb. The mentioned disadvantages in the configuration according to the prior art are thus advantageously avoided.

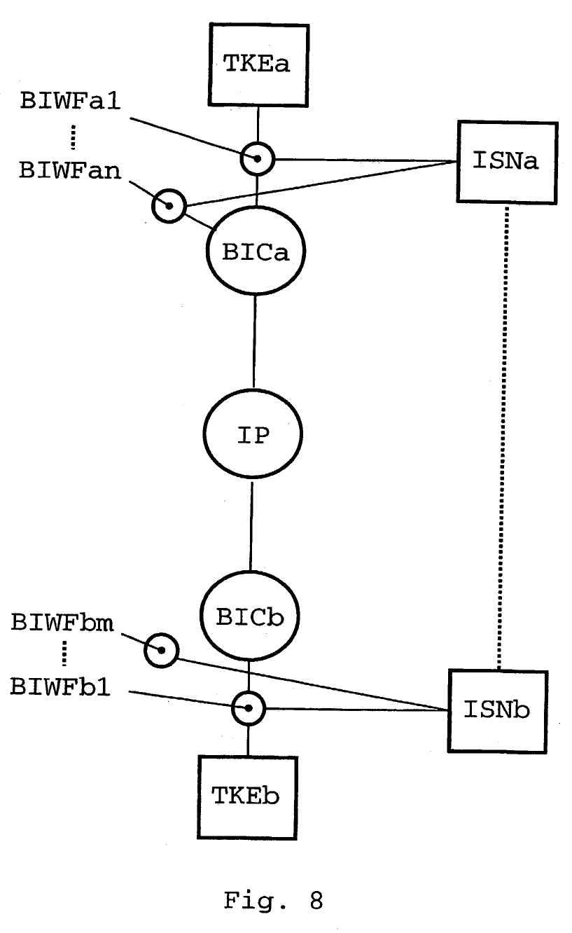

An example of a network configuration according to the invention is shown in FIG. 8. In accordance with the invention the first and second gateway serving nodes GSNa and GSNb and the first and the second gateway bearer interworking function G-BIWFa and G-BIWFb have been removed here based on the arrangement shown in FIG. 7. Both the first telecommunication network BICa and the third telecommunication network IP and the second telecommunication network BICb are now linked directly. Analogously there now exists a direct logical link between the first and second interface serving nodes ISNa and ISNb.

The functionality of an interface module INT can now be covered by the functionality of an interface serving node ISN in which the function of one of the gateway serving nodes GSN has been integrated and/or the link model running in the interface module INT contains both the functionality of gateway serving nodes GSN and that of interface service nodes ISN. Furthermore, the bearer interworking functions BIWF can also be integrated in the link model.

For reasons of greater clarity, reference was made in the exemplary embodiment only to links between two telecommunication terminals TKE. However, the invention also covers other types of links in a telecommunication network. For example, a bearer interworking function BIWF can also be provided as an endpoint of a link.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. A method for controlling a link in a telecommunication network, said link operating between at least a first and a second telecommunication terminal, comprising the steps of:
generating a model of said link in a programmable computer;
setting said model to an initial status assigned to a status of said link,
triggering in said model assigned status changes upon carrying out first measures which are implemented in said telecommunication network in relation to said link,
implementing second measures in said model, and
with the aid of the behavior of the model based on a second measure, making a decision whether said second measure, another measure or no measure is implemented in said telecommunication network.

2. The method according to claim 1, wherein said link model is formed of objects and their connections, and further comprising the steps of:
generating or deleting assigned objects in a programmable computer upon implementing said first measures,
connecting or disconnecting multiple assigned objects from one another upon implementing said first measures, and
optionally changing assigned parameters used in said model upon implementing said first measures.

3. The method according to claim 1, further comprising the steps of:
providing a model of a send channel as a first object,
providing a model of a receive channel as a second object,
providing a model of a switching element for connecting and disconnecting a receive channel from a send channel and vice versa as a third object,
providing a model of a signal generator as a fourth object and linking a send channel of said fourth object is linked to a receive channel of another object,
providing a model of a signal receiver as a fifth object and linking a receive channel of said fifth object to a send channel of another object,
providing a model of a combined signal source/sink as a sixth object and linking a send channel of said combined signal source/sink to a receive channel of another object, and linking a receive channel of said combined signal source/sink to a send channel of another object, and
optionally providing a conversion element for converting an address of a telecommunication terminal from one address format to another address format as a seventh object.

4. The method according to claim 2, further comprising the steps of:
providing a model of a send channel as a first object,
providing a model of a receive channel as a second object,
providing a model of a switching element for connecting and disconnecting a receive channel from a send channel and vice versa as a third object,
providing a model of a signal generator as a fourth object and linking a send channel of said fourth object is linked to a receive channel of another object,
providing a model of a signal receiver as a fifth object and linking a receive channel of said fifth object to a send channel of another object,
providing a model of a combined signal source/sink as a sixth object and linking a send channel of said combined signal source/sink to a receive channel of another object, or linking a receive channel of said combined signal source/sink to a send channel of another object, and
providing a conversion element for converting an address of a telecommunication terminal from one address format to another address format as a seventh object.

5. The method according to claim 3, wherein said telecommunication network comprises a bearer independent call control network, and further comprising the steps of:
integrating a functionality of a gateway serving node, into said model,
integrating a functionality of an interface serving node into said model,
integrating a bearer interworking function into said model, and
optionally integrating a gateway bearer interworking function into said model.

6. The method according to claim 5, wherein said functionality of a gateway servicing node comprises an element pertaining to a gateway bearer interworking function.

7. The method according to claim 4, wherein said telecommunication network comprises a bearer independent call control network, and further comprising the steps of:
integrating a functionality of a gateway serving node, into said model,
integrating a functionality of an interface serving node into said model,
integrating a bearer interworking function into said model, and
optionally integrating a gateway bearer interworking function into said model.

8. The method according to claim 7, wherein said functionality of a gateway servicing node comprises an element pertaining to a gateway bearer interworking function.

9. A method for controlling a link in a first telecommunication network, said link operating at least a first and a second telecommunication terminal, comprising the steps of:
implementing in said first telecommunication network, a first set of measures for achieving a defined status of said link in relation to two endpoints;
implementing in said second telecommunication network a second set of measures for achieving said status of said link in relation to said two endpoints;
generating a model of said link of said second telecommunication network in a programmable computer,
setting a model to an initial status assigned to a status of said link;
upon implementing said first measures in said first or second telecommunication network in relation to said link, triggering assigned status changes in said model,
implementing second measures of said first or second telecommunication network in said model, and
with the aid of the behavior of the model based on a second measure, deriving a measure and optionally implementing it in said first and/or second telecommunication network.

10. The method according to claim 9, wherein said link model is formed of objects and their connections, and further comprising the steps of:
generating or deleting assigned objects in a programmable computer upon implementing said first measures,
connecting or disconnecting multiple assigned objects from one another upon implementing said first measures, and
optionally changing assigned parameters used in said model upon implementing said first measures.

11. The method according to claim 9, further comprising the steps of:
providing a model of a send channel as a first object,
providing a model of a receive channel as a second object,
providing a model of a switching element for connecting and disconnecting a receive channel from a send channel and vice versa as a third object,
providing a model of a signal generator as a fourth object and linking a send channel of said fourth object is linked to a receive channel of another object,
providing a model of a signal receiver as a fifth object and linking a receive channel of said fifth object to a send channel of another object,
providing a model of a combined signal source/sink as a sixth object and linking a send channel of said combined signal source/sink to a receive channel of another object, and linking a receive channel of said combined signal source/sink to a send channel of another object, and
optionally providing a conversion element for converting an address of a telecommunication terminal from one address format to another address format as a seventh object.

12. The method according to claim 10, further comprising the steps of:
providing a model of a send channel as a first object,
providing a model of a receive channel as a second object,
providing a model of a switching element for connecting and disconnecting a receive channel from a send channel and vice versa as a third object, providing a model of a signal generator as a fourth object and linking a send channel of said fourth object is linked to a receive channel of another object,
providing a model of a signal receiver as a fifth object and linking a receive channel of said fifth object to a send channel of another object,
providing a model of a combined signal source/sink as a sixth object and linking a send channel of said combined signal source/sink to a receive channel of another object, and linking a receive channel of said combined signal source/sink to a send channel of another object, and optionally providing a conversion element for converting an address of a telecommunication terminal from one address format to another address format as a seventh object.

13. The method according to claim 9, wherein said telecommunication network comprises a bearer independent call control network, and further comprising the steps of:
integrating a functionality of a gateway serving node, into said model,
integrating a functionality of an interface serving node into said model,
integrating a bearer interworking function into said model, and
optionally integrating a gateway bearer interworking function into said model.

14. The method according to claim 13, wherein said functionality of a gateway servicing node comprises an element pertaining to a gateway bearer interworking function.

15. The method according to claim 10, wherein said telecommunication network comprises a bearer independent call control network, and further comprising the steps of:
integrating a functionality of a gateway serving node into said model,
integrating a functionality of an interface serving node into said model,
integrating a bearer interworking function into said model, and
optionally integrating a gateway bearer interworking function into said model.

16. The method according to claim 15, wherein said functionality of a gateway servicing node comprises an element pertaining to a gateway bearer interworking function.

17. The method according to claim 11, wherein said telecommunication network comprises a bearer independent call control network, and further comprising the steps of:
integrating a functionality of a gateway serving node, into said model,
integrating a functionality of an interface serving node into said model,
integrating a bearer interworking function into said model, and
optionally integrating a gateway bearer interworking function into said model.

18. The method according to claim 17, wherein said functionality of a gateway servicing node comprises an element pertaining to a gateway bearer interworking function.

19. A method for controlling a link in a telecommunication network, said link operating between at least a first and a second telecommunication terminal, wherein said telecommunication network is built up of technologically differing subnetworks, and comprising the steps of:
providing a bearer independent call control network for one subnetwork; and
integrating a functionality of a gateway serving node.

20. The method according to claim 19, further comprising the steps of:
routing switching of a bearer channel via a first bearer interworking function and a second bearer interworking function, and
wherein said step of integrating a functionality further comprises integrating an element pertaining to a gateway bearer interworking function G-BIWF into functionality of an interface service node.

21. The method according claim 19, further comprising the steps of mapping in a model of a link in said telecommunication network: a functionality of a gateway serving node, a functionality of an interface serving node, a bearer interworking function, and optionally a gateway bearer interworking function.

22. The method according claim 20, further comprising the steps of mapping in a model of a link in said telecommunication network: a functionality of a gateway serving node, a functionality of an interface serving node, a bearer interworking function, and optionally a gateway bearer interworking function.

23. The method according to claim 21, wherein said functionality of a gateway comprises an element pertaining to a gateway bearer interworking function.

24. The method according to claim 22, wherein said functionality of a gateway comprises an element pertaining to a gateway bearer interworking function.

25. A system for controlling a link in a first telecommunication network, said link operating at least a first and a second telecommunication terminal, comprising:
a programmable computer programmed for storing and administering a model of a link in a telecomnunication network, said model further comprising means for triggering changes of state with status changes being assigned to first measures which are implemented in said teleconununication network and means for implementing second measures;
means for evaluating behavior of said model based on a second measure and means for deciding whether said second measure, another measure or no measure is implemented in said telecommunication network, and
means for implementing a measure in the telecommunication network based on said model.

26. The system according to claim 25, further comprising:
an end-to-end logical link between a first interface serving node and a second interface serving node, said first interface serving node linked to first bearer interworking functions, and optionally said second interface serving node linked to second bearer interworking functions.
